(19) United States
(12) Patent Application Publication
(10) Pub. No.: US 2013/0097671 A1
(43) Pub. Date: Apr. 18, 2013

(54) DEVICE AND METHOD FOR INTERFACING AT LEAST ONE DATA STORAGE AND TRANSMISSION TERMINAL WITH AT LEAST ONE DATA TRANSMISSION MEDIUM

(71) Applicant: Eric Fouchard, Bruz (FR)

(72) Inventor: Eric Fouchard, Bruz (FR)

(73) Assignee: SAS TAZTAG, Bruz (FR)

(21) Appl. No.: 13/700,669

(22) PCT Filed: May 28, 2010
(86) PCT No.: PCT/EP2010/057460

§ 371 Date: Dec. 26, 2012

(51) Int. Cl. H04L 29/06

(52) U.S. Cl. CPC H04L 63/08
USPC 726/3

(57) ABSTRACT

The invention relates to a secure interfacing device (20), suitable for storing at least one tag (30), and/or transferring the tag to at least one data storage and transmission terminal (1), comprising:
means (22) for detecting and extracting at least one of said tags and/or at least one item of information suitable for downloading at least one tag, in a data stream;
means (29) for managing and/or storing said tag(s);
means (23) for receiving a transmission request (2001) of at least one tag, sent by one of said terminals;
first means (24) for the radiofrequency transmission of said at least one tag to said terminal (1).

### FIELD OF THE INVENTION

The field of the invention is that of communication between a terminal suitable for receiving, storing, processing and transmitting data and an external environment.

More specifically, the invention relates to the secure connection of terminals provided for communicating within a small perimeter, up to a few hundred meters, via near field communication (NFC) techniques and by radiofrequency, for example based on ZigBee® or Wifi technology, particularly for providing said terminals with specific data sequences, or tags, which may for example be commercial information.

### PRIOR ART

Such terminals, particularly described in the patent application FR-0804751, comprise near field communication means, for initiating a data exchange with another terminal or a server, when the two elements are positioned near each other (typically a few centimeters), and radiofrequency communication means, for continuing the previously initiated data exchange, allowing a distance between the two elements.

In this way, these terminals, hereinafter referred to as data storage and transmission terminals, or more generally as terminals, are suitable for securing the initiation of a data exchange, by requiring a very close distance (and preventing, for example, a malicious third party from intercepting the exchanged data). The exchange can then continue at a greater distance, with the possibility of ensuring further confidentially using keys, codes, encrypted data and/or the transmission of a portion of the necessary data at the time of initiation.

Such terminals may be equipped with biometric recognition means, enabling secure identification requiring no specific action, such as the provision of an identification code.

These terminals thus fulfill a dual requirement in respect of security (identification, authentication and/or encryption) and simplicity (ergonomics, space required, cost, etc.).

It is thus desirable to broaden the scope thereof as much as possible, particularly via optimized and easy tag provision.

### SUMMARY OF THE INVENTION

For this purpose, the invention particularly relates to a secure interfacing device, suitable for storing at least one specific data sequence, referred to as a tag, and/or transferring the tag to at least one data storage and transmission terminal, said tag including setting data and informative data.

According to the invention, such a device comprises:
means for obtaining at least one stream of multimedia data broadcast via one or a plurality of transmission media;
means for detecting and extracting at least one of said tags and/or at least one item of information suitable for downloading at least one tag, in said data stream;
means for managing and/or storing said tag(s);
means for identifying and/or authenticating one of said terminals, using near field communication means;
means for receiving a transmission request of at least one tag, sent by one of said terminals;
first means for a radiofrequency transmission of said at least one tag to said terminal.

In this way, the interfacing device according to the invention acts as a tag server. It is suitable for extracting tags in broadcast and/or downloaded signals, or streams, and for transmitting same on request to a terminal, after the terminal has undergone identification with the interfacing device.

This identification (or authentication, depending on the protocols) is performed via an NFC link, requiring a close vicinity between the interfacing device and the terminal (a few centimeters) and so securing data exchange. Subsequent data exchange for tag requests and downloads is carried out at greater distances, via a radiofrequency link.

In this way, the interfacing device according to the invention is suitable for communicating with the terminals in near field mode, particularly for initiating a data exchange, and in radiofrequency mode. Moreover, it is capable of receiving, or obtaining, via a data transmission medium, or channel, (which may for example be an Internet connection), a data stream (particularly a video or multimedia stream or a television signal) and obtaining, according to the stream, at least one tag, i.e. an electronic tag tagging a portion of the data, intended for one or a plurality of terminals.

According to the embodiments, a tag may be extracted directly from the data stream, the tag being inserted in the steam, and/or indirectly, a set of at least one tag being downloaded from a remote site on the basis of an item of information extracted from the stream.

As shown more clearly hereinafter, the interfacing device can thus, for example, extract such tags from a field provided for this purpose in a video stream, following a remote server request (via, if applicable, a home gateway connected to the Internet), or in broadcast television signals.

In this way, in some embodiments of the invention, said obtaining means comprise means for downloading said data stream, from at least one remote server.

For example, the stream may be downloaded on the Internet, or obtained by means of “streaming” on the Internet. It may particularly consist of a retransmission of a television program, accessible from a website.

In further embodiments, the data stream is a broadcast signal. In this case, the interfacing device retrieves these tags, analyzing the stream received, and sends the tags (or makes said tags available) to the terminal.

It may particularly consist of a television signal, comprising data acting as tags (or data suitable for accessing the tags). In this case in particular, the interfacing device may be incorporated into a television set.

According to the embodiments, it may for example consist of tags relating to a survey, advertising tags (particularly discount vouchers), and more generally information of interest to the bearer of the terminal (news, games, people with the same profile, etc.). This is easy to implement, because, in the case of NFC initiation, the terminal can transmit identification data and/or personal data securely to the interfacing device, which can then handle itself security and confidentiality with a server.

According to a further aspect, the device may act as a tag server, for one or a plurality of terminals.

According to one particular embodiment of the invention, said setting data comprises time-stamp data, defining a validity start time and/or end time and/or a validity period, and said tag management and/or storage means control the storage and/or transfer of said tags to at least one terminal on the basis of said time-stamp data.

In this way, the interfacing device can handle the tags extracted and store these tags on the basis of the time-stamp date, for example, not supplying the tags before a specific time stamp or deleting said tags when they are no longer valid.

According to a further particular embodiment of the invention, which can optionally be combined with the above embodiment, said setting data includes data for characterizing said informative data, and said tag management and/or storage means control the storage and/or transfer of said tags to at least one terminal based on a comparison between said characterization data and configuration information stored in said interfacing device and/or provided by one of said terminals.

The management can thus take account of further settings, provided by the terminal, and particularly information on the owner of the terminal (age, sex, geographical address, marital status, preferences entered or determined by the terminal, etc.).

It is thus possible to manage preferences or settings, for selecting stored tags and/or tags made available to the terminals, based on users' wishes and information provided by the users.

If a plurality of terminals is connected to the interfacing device, management can obviously be customized, based on the preferences defined by each terminal.

According to a particular embodiment of the invention, the interfacing device may comprise means for managing the transfer of at least one tag to a terminal, comprising means for proposing the transfer of at least one tag, means for requesting the transfer of at least one tag and means for transferring said tag.

In particular, the interfacing device may offer a terminal a list of tags likely to be of interest. The user can thus choose, via the terminal, the tags to be received, from those proposed.

According to one particular embodiment of the invention, the interfacing device comprises means for receiving a response to a tag, transmitted by one of said terminals, and means for transmitting said response to a remote server.

It may for example consist of a response to a survey, specific commands, or a selection by a user of the terminal for an interactive television program. The terminal, via the device, may react to a prompt (subject to a tag) for example. Interactive exchanges are thus available.

According to a particular feature of the invention, the interfacing device comprises second means for radiofrequency transmission with a telephone and/or Internet network connection gateway.

In this case, it is not dependent on a wired connection, but incorporates three reception and transmission means, based on three separate protocols, for example NFC and ZigBee® for exchanges with the terminals, and Wifi for exchanges with the gateway.

According to a particular feature of the invention, the interfacing device comprises means for certifying and/or authenticating said response, based on at least one certification and/or authentication data item transmitted by said transmission request.

This certification and/or authentication data is exchanged via near field communication means. These means enable simple user authentication by the terminal, in the interfacing device and then, via this device, in a remote server.

Authentication or identification, at the terminal end, may be carried out simply, by biometric means such as fingerprint scanning for example.

In this way, for example in the case of a vote, a significant degree of security is ensured. In particular, it is possible to ensure that a user does not vote several times, or, on the contrary, track the progression of the user's opinion, if it is envisaged that the user can, or should, vote several times.

According to one particular embodiment of the invention, said information for downloading said tag comprises at least one synchronization information item defining a validity start time and/or end time, a validity period and/or a synchronization data item with said tag to be downloaded, and the device comprises means for controlling the download of said tag, based on said synchronization information.

In this way, it is possible to use synchronization for downloading tags. This synchronization may be absolute (a period is defined, for example for a vote or a survey, particularly a real-time survey, or on the basis of the advertising contract start and end dates between a company and a television channel) or relative (based for example on the viewing point of a movie, a specific “time code”, or a movie sequence, loaded via VOD (video on demand), for access to a special offer based on the viewed sequence).

It is important to note that, in this case, the provision of tags may be dependent on the user (settings (age, sex, preferences, etc.) provided by the user at start-up, in NFC, for example) and also synchronization information.

According to a particular feature of the invention, the interfacing device according to the invention may further comprise second radiofrequency transmission means with a telephone and/or Internet network connection gateway.

In this case, it is not dependent on a wired connection, but incorporates three reception and transmission means, based on three separate protocols, for example NFC and ZigBee® for exchanges with the terminals, and Wifi for exchanges with the gateway.

According to a particular feature of the invention, the interfacing device may comprise setting, encoding and/or encryption means based on setting, encoding and/or encryption data exchanged via said near field communication means.

In this way, the exchanges may be secure and personalized.

In one particular embodiment, said means for obtaining the device according to the invention comprise means for opening and implementing a data transmission channel between a terminal and at least one data transmission medium, via said connection gateway.

In this way, without a computer, it is possible to exchange data with a server. This can for example be used to take part in surveys, interactive games, influence a television program, etc.

These means for opening and implementing a data transmission channel may comprise means for converting signals between said first radiofrequency transmission means (transmission between the device and the terminal) and the second radiofrequency transmission means (transmission between the device and the gateway).

According to a particular feature of the invention, said first radiofrequency transmission means and/or said second radiofrequency transmission means belong to the group comprising communication means implementing a protocol such as ZigBee®, Bluetooth®, 6LoWPAN®, Ethernet® or Wifi.

The invention also relates to a secure interfacing method, for storing at least one specific data sequence, referred to as a tag, and/or transferring the tag to at least one data storage and transmission terminal, said tag comprising setting data and informative data.

Such a method particularly comprises:
a step for obtaining at least one stream of multimedia data broadcast via one or a plurality of transmission media;
a step for detecting and extracting at least one of said tags and/or at least one item of information suitable for downloading at least one tag, in said data stream;
a step for managing and/or storing said tag(s);
a step for identifying and/or authenticating one of said terminals, using near field communication means;
a step for receiving a transmission request of at least one tag, sent by one of said terminals;
a step for the radiofrequency transmission of said at least one tag to said terminal.

The method may also comprise, in particular, a step for exchanging data with a connection gateway to a telephone and/or Internet network, using second radiofrequency transmission means.

According to a particular application of the invention, the data transmitted by a terminal, via an interfacing device, may be used to vote or to take part in surveys. In particular, it is possible to vote in real time, or at least in a synchronized manner, according to the tags received by the terminal. It is thus possible to implement, in a server, detailed tracking of votes and the progression thereof, and track, for example in real time, the progression of responses to a question, and if applicable render information changing over time.

This may for example be used to track, during a political debate, the progression of the rating of each speaker, the user being invited to give an opinion regularly, via a time-stamped tag. The validity, and if applicable, uniqueness of the response can be checked using time stamping and using the user identifier. According to the circumstances, it may be envisaged that prior registration is required for the votes (or tags) to be taken into account.

A similar approach may be used for tracking television channel audiences, the impact of an advertising campaign or to propose online betting.

### LIST OF FIGURES

Further features and advantages of the invention will emerge more clearly on reading the following description of a preferential embodiment of the invention, given as a mere illustrative and non-limiting example, and the appended figures, wherein:

FIG. 1 shows an embodiment of the invention in a home audiovisual broadcasting context;

FIGS. 2A and 2B illustrate the structure and hierarchical arrangement of the means of a device according to an embodiment of the invention;

FIG. 3 represents the constituent elements of a tag;

FIG. 4 illustrates the structure of the tag management means.

### DESCRIPTION OF AN EMBODIMENT

The invention relates to an interfacing device suitable for communicating with terminals (for example of the type described in the document FR-0804751 mentioned above) in near field mode and in radiofrequency mode.

According to the invention, such an interfacing device is particularly suitable for extracting a data sequence (tags) intended for one or a plurality of terminals of a data stream received or obtained via a channel, or a data transmission medium, which may be connected to a remote server or to a video on demand system or to a television signal receiver for storing and/or transmitting the sequence to terminals.

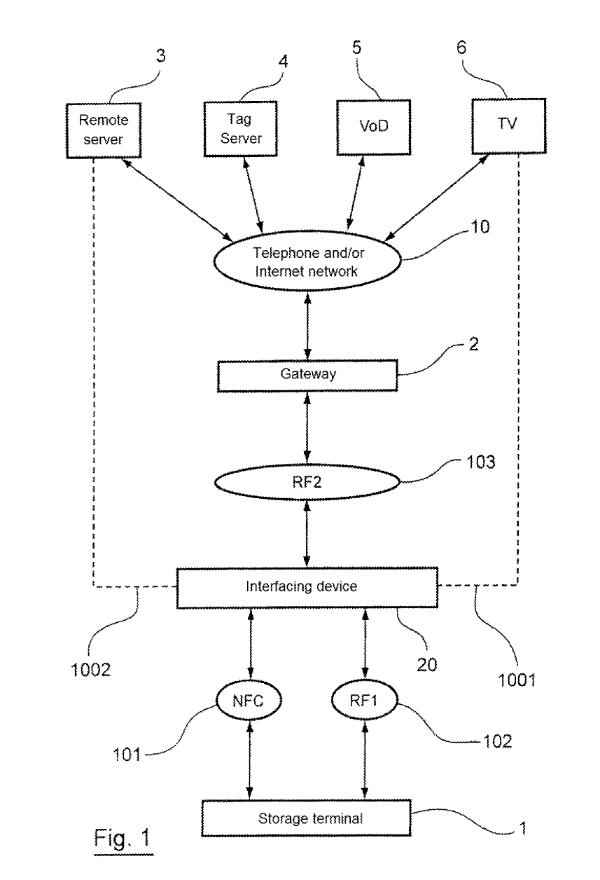

With reference to FIG. 1, an example of an embodiment of the invention in a home audiovisual broadcasting context is shown hereinafter.

In all the figures of the present document, identical elements are designated with the same numerical reference.

As illustrated, the interfacing device 20 according to the invention can communicate in three different forms, i.e.:
via near field transmission NFC 101 with a storage terminal 1 as described for example in the patent application FR-804751;
via a first type of radiofrequency transmission RF1 102 with the storage terminal 1, for example based on the Zigbee® protocol;
via a second type of radiofrequency transmission RF2 103 communicating via a connection gateway 2 to a telephone and/or Internet network 10 to which a set of remote devices is connected, for example based on the Wifi protocol.

According to a further particular embodiment, a single protocol may be used for communicating in radiofrequency mode with the terminals and with the gateway.

The gateway 2 may for example be an electronic device provided by an Internet service provider to the ADSL subscribers thereof. Such a gateway, commonly referred to as a “Box”, and connected to the radiofrequency transmission network RF2 103 enables the interfacing device to communicate and exchange data with multiple remote or local devices. In a home audiovisual broadcasting context, these devices may for example be a remote data server 3, a website (not shown), a video on demand server 5 (“VoD”), a television set 6, a tag server.

A tag may for example be an item of commercial information, which may be adapted to the connection gateway user's profile or an item of information in respect of the required age for viewing a movie, etc.

The devices mentioned above may also communicate together.

According to one alternative of this embodiment, the interfacing device according to the invention can communicate directly with one of the devices, based for example on a link 1002 with a remote server or a link 1001 with a television set. The link 1002 may consist of a USB cable, the interfacing device comprising a USB socket in this case. In the case of the link 1001, said link may be a SCART cable, with the interface device comprising a SCART socket if applicable.

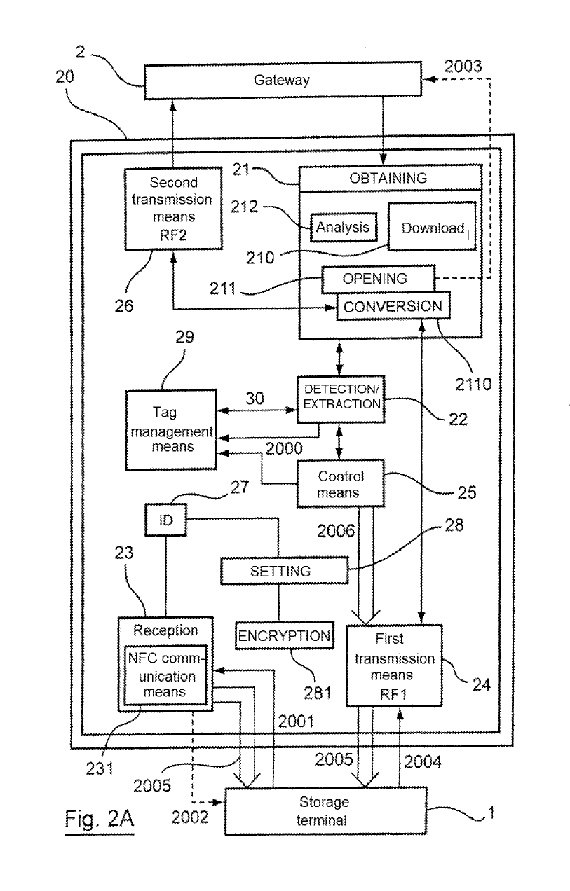

FIGS. 2A and 2B illustrate the structure and hierarchical arrangement of the means of an interfacing device 20 according to an embodiment of the invention.

According to FIG. 2A, the interfacing device, located in a room, obtains a data stream via the connection gateway 2. For this purpose, the device 20 may use means 210 for downloading this data provided by a remote server (not shown in FIG. 2A) and transiting on the connection gateway.

This data is then analyzed by data stream analysis means 212, and processed by detection and/or extracting means 22 so as to detect and obtain tags, either by extracting tags found in the stream, or by extracting information for downloading tags, these tags being intended to be transmitted to at least one storage terminal in the vicinity via first transmission means RF1 24.

These tags are subsequently processed and stored by tag management and/or storage means 29.

Indeed, no terminal may be present when the tags are obtained, giving rise to the storage of said tags if applicable.

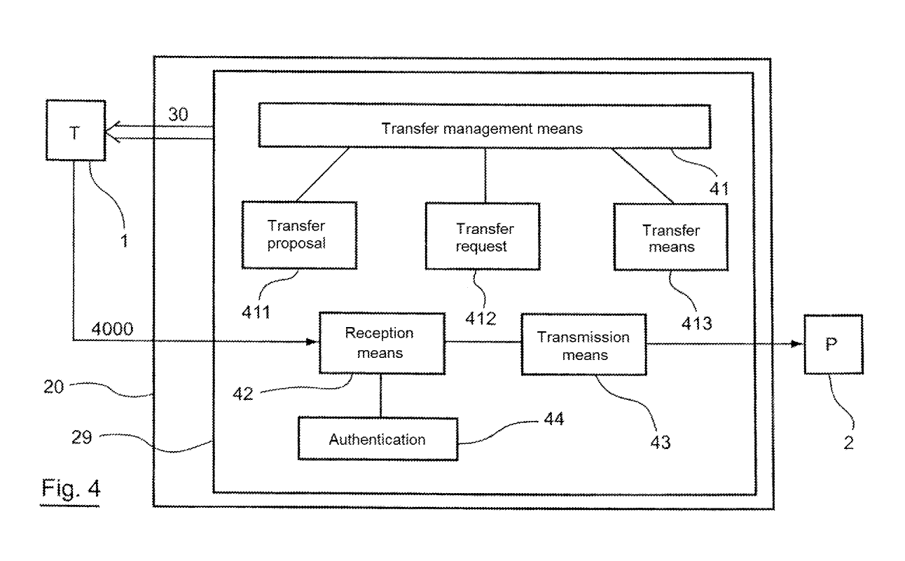

The management and/or storage of said tags comprises transmission of the extracted tags, directly or indirectly, and/or configuration information 2000 by detection and/or extraction means 22 to the tag management means 29, the operation whereof is explained in detail in FIG. 4.

According to a further alternative embodiment, the configuration information may also be provided by terminals.

Tag management and/or storage may also comprise, in the case of a tag downloaded using information extracted from the stream, the transmission to the tag management means 29 of at least a portion of the extracted information, used for downloading the tag, such as at least one item of synchronization information defining a validity start and/or end time, a validity period, and/or synchronization with the downloaded tag.

In this case, the tag download may be controlled by control means, based on the synchronization information.

The provision 2005 and/or transmission of said tags by the first transmission means RF1 24 and/or the NFC communication means 231 is subsequently controlled 2006 by control means 25, based on said synchronization information. According to the embodiments, the control means may be independent of the means for controlling the tag download or, as illustrated in FIG. 2A, the same control means.

If a user carrying a storage terminal enters the room, the user can, for example by pressing a button starting identifier transmission operations (the terminal may have previously identified the user, for example using biometric recognition means), log into the device 20, sending a transmission request 2001 for at least one tag.

This request is transmitted via NFC. The terminal should thus be positioned near the device (a few centimeters—this short distance enables secure transmission).

The device receives this request via reception means 23 using near field communication means 231.

The request is then identified and authenticated by identification and/or authentication means 27. For example, it is possible to determine whether the terminal is authorized to communicate with the interfacing device or not, or it is possible to determine the age of the user of the storage terminal, etc.

The device can send back an acknowledgement signal, confirming that the request has been taken into account. In some embodiments, it can be envisaged for the identification to be requested periodically (for example every hour) and/or when a predetermined inactive interval has elapsed.

The degree of authentication and identification of the data exchanged with the storage terminal can be set using setting means 28, and this data may, if applicable, be encoded and/or encrypted, based on the security level required by the user and/or based on the type of data exchanged, by encoding and/or encryption means 281.

According to one alternative embodiment, the interfacing device may also send an identification request 2002 in order to be identified and authorized to communicate by the terminal.

According to the embodiment represented herein, the control means decide on the provision of the specific data based on the synchronization information and/or the terminal authentication.

Indeed, depending on the time of arrival from the terminal, the validity of the tags and/or specific data may have elapsed.

Moreover, the only specific data available may for example be aimed at an adult audience over 18 years of age, for example in the case of tags inserted during a political debate on a referendum. In this case, if the bearer of the storage terminal is underage for the political program broadcast, the control means 25 will block access to such tags.

The data may also consist of a restriction of tag transmission associated with a subscription, for example subscription to a television channel package.

According to one alternative embodiment, not shown, the control means may also “clear” stored tags for which the validity has expired.

Furthermore, the interfacing device may also comprise opening means 211 (included in the obtaining means 21) suitable for requesting 2003 the use of a data transmission channel between a terminal and at least one remote server via said connection gateway 2.

Moreover, the storage terminal 1 may also, after authentication, transfer, by means of an RF link, via the first transmission means RF1 24, data 2004 suitable for being converted by conversion means 2110 used by the opening means 211, and transmitted to a remote server by second transmission means RF2.

In practice, most of the elements described above can be grouped together and organized as illustrated in FIG. 2B.

In this figure, the interfacing device described in detail below is shown as follows:
an NFC interface 51, containing all the elements affecting the specific data transiting via the NFC network;
an RF1 interface 52, containing all the elements affecting the specific data transiting via the RF1 network;
an RF2 interface 54, containing all the elements affecting the specific data transiting via the RF2 network;
a microprocessor 55;
a RAM memory 53 (and/or another data storage means) essentially intended for storage specific data;
a program memory 56 (which may be the same memory as the memory 53 in some embodiments).

The microprocessor 55 controls the various other elements and, according to the program(s), the functions detailed above.

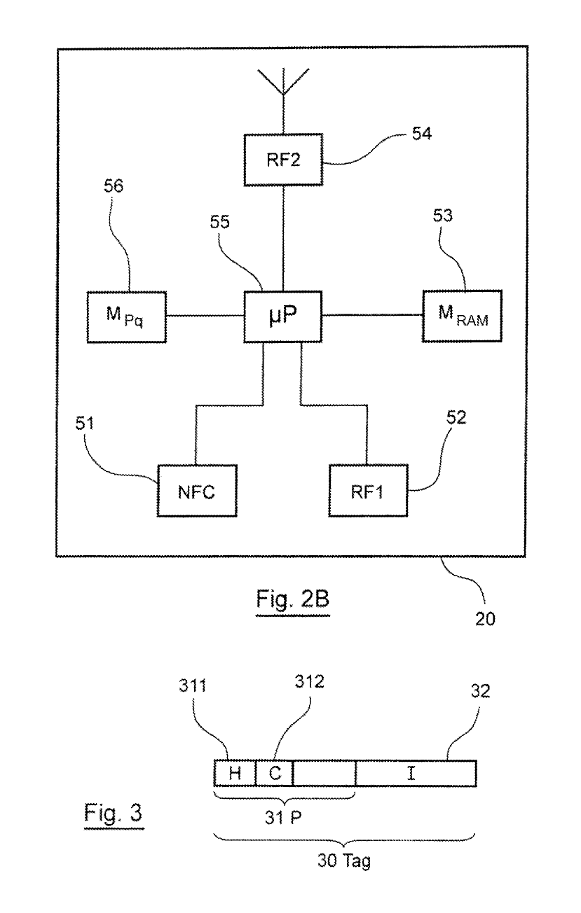

FIG. 3 represents the constituent elements of an example of a tag 30. Indeed, a tag 30 consists of setting data 31 and informative data 32. Moreover, the setting data may particularly comprise:
time-stamp data 311 defining a validity start time and/or end time and/or a validity period. The tag management means 29 can control the storage and/or transfer of said tags to at least one terminal on the basis of said time-stamp data;
data 312 characterizing said informative data 32, such that said tag management means 29 control the storage and/or transfer of said tags to at least one terminal based on a comparison between said characterization data 312 and configuration information 2000 stored in the processing and/or storage means 22 according to the embodiment.

FIG. 4 illustrates a detailed structure of the tag management means 29, according to one embodiment.

Indeed, the tag management means 29, comprise transfer management means 41 which, based on the time-stamp data 311 and the comparison between the characterization data 312 and the configuration information 2000, controls the transfer of a tag to a terminal. For this purpose, these transfer means 41 may use:
means 411 for proposing the transfer to the terminal 1 of at least one tag, the user of the terminal being then able to select the tag to be received;
means for requesting the transfer of the tag selected by the user 412;
means for transferring tags 413;
means 42 for receiving a response 4000 to a tag;
means for transmitting said response to a remote server via the connection gateway 2.

According to one embodiment of the invention, the means 42 for receiving a response 4000 to a tag also use certification and/or authentication means 44. For example, when following a referendum, the user, whose age will have been authenticated, may choose to respond to a tag representing an issue subject to a live debate, and the user's validated and authenticated response may be retransmitted via the interfacing device to a remote server suitable for quasi-direct statistical processing.

### Examples of Application

The process according to the invention makes it possible to acquire, in real or quasi-real time, a reaction from subjects receiving broadcast information, for example a political debate, a singing competition, a television game show, etc.

This can particularly enable optimized trend tracking, accounting for progression over time. A server, accessible via the Internet for example, can render the trends, for example in the format and layout usually used for stock market prices. In this case, in real time, information is obtained on the rating of a person, product or idea, and immediate adaptations or analyses can be deduced therefrom.

The interfacing device according to the invention is particularly suitable for such applications, since it is suitable for receiving a vote or opinion provided by a terminal and transmitting same to the remote server performing the compilation, analysis and rendering. At least one of the following items of information can be associated with this vote:
time-stamp information (absolute or relative with respect to the broadcast signal);
identification information (for example to prevent multiple votes from the same user, or at the contrary to reward users voting several times, or for more detailed trend tracking);
user profile information (sex, age, profession, etc.).

The latter two items of information are particularly supplied to the interfacing device by a terminal, preferably via the NFC link, at least for the identification information. It should be noted that a plurality of terminals may be associated with the same interfacing device (for example one for each member of a family) and that the interfacing device can transmit a plurality of separate votes accordingly.

Obviously, this information may be encrypted, if required.

According to the applications, voting may be carried out at any time, enabling the user to respond to a situation immediately or be prompted, for example in real time. In the latter case, the interfacing device may receive a prompt tag (“answer the following question: . . . ”), providing a period for a response if applicable. The information transmitted at the same time as the vote may then also include a tag identifier.

In the case of competitions, or bets, or games, feedback information (“lost”, “won”, “your winnings are . . . ”) may be sent back to the user. In one particular embodiment, this information may consist of tags, offering commercial information (discount vouchers, offers adapted to a user, based on the user's responses and profile, if applicable, etc.).

More generally, this provision of commercial information may particularly be based on a profile or a configuration. For example, tags aimed at children will be adapted accordingly and subject to control if applicable. In this way, the transfer of a tag to a child may be subject to a transfer authorization given by one of the parents. The interfacing device handles the data exchanges required for this operation.

As a more general rule, the interfacing device may enable parental (or other) control, authorizing access to certain applications, sites, movies, types of tags, etc. and/or controlling usage time.

Tag tracking may be associated with a broadcast signal, for example a movie downloaded via VOD. For example, when the hero of the movie gets into his vehicle, a tag proposing a test drive of the vehicle may be transmitted. In this case, synchronization between the broadcast, or playback of the movie, is envisaged. Numerous embodiments can be envisaged:
the tags are inserted into the downloaded movie signal, and read at the appropriate time by said device;
the tags are provided by a separate remote server, in the form of one or a plurality of batches associated with the movie, and downloadable via at least one information item contained in the downloaded movie signal, and proposed to the terminal, by the interfacing device, at the required times:
   based on predefined times with respect to the start of the movie;
   based on the information contained in the movie signal:
      specific code entered in the signal;
      Synchronization data (“time code”) contained in the signal;
      portion of the signal (for example start of an image;
      etc.

The embodiments wherein the tags are provided by a separate tag server are thus suitable for managing and editing the batch of tags associated with a multimedia signal.

The proposed tags may for example be dependent on the television channel or the movie or report-broadcasting mode.

For example, an advertising tag encouraging users to subscribe to an encrypted television channel or subscribe to additional services may be proposed during the broadcast of a movie (“in unencrypted mode” for example) by the channel.

However, the tag will not be proposed during a broadcast of the movie by another channel.

The tags proposed may also be dependent on the user's subscription to specific services offered via tags. In this way, a user who has subscribed to a specific service may receive, via a tag, an offer of additional information on the program or movie being viewed (for example a summary, a list of related publications or websites, etc.).

Different tags may also be obtained according to the time of the movie broadcast. For example, batches of tags that can be downloaded during the summer would place more emphasis on leisure or travel-related service offers and those that can be downloaded at Christmas time would place more emphasis on gifts or good food, etc.

The choice may also take account of information present on the terminal and/or the interfacing device, characterizing the user (age, sex, profession, preferences, areas of interest, previous downloaded tags, etc.).

A further application of the invention is that of broadcasting advertisements. A tag may be associated with an advertisement, providing more information and, if applicable, a commercial benefit (discount, free option, invitation, etc.). Furthermore, the management of an advertising campaign can be adapted, using a similar mechanism to that suggested above for voting.

Numerous applications may also be envisaged, such as online or network games, the interfacing device managing exchanges with one or a plurality of terminals and/or a remote site.

A further application is that of linking with other devices, for example for intelligent home applications. In this case, the interfacing device can provide the link between heating, air conditioning, audio-video means, etc., and one or a plurality of terminals, acting as a remote control (and receiving, if applicable, status information on the other devices). The interfacing device can be used to centralize commands received from multiple terminals and, if required, handle arbitration, time delays or priorities (for example, to give priority to a parent's terminal over a child's terminal).

The interfacing device may also provide the terminals with applications (“applets” for example), definitively or temporarily, in order to assign the terminals an additional function (keyboard for example). It may also authorize the user of a device (separate keyboard for example), if applicable, provided that the terminal is near the device (the proximity being controlled by the NFC means).

According to the circumstances, the interfacing device may act as a server and monitoring system. For example, it can store a series of tags, and make them available to the terminals, so that the terminals only load them if required. Regularly, a terminal can query the interfacing device, to obtain a list of available tags (and download, delete or forward tags).

The interfacing device can take account of synchronization data, in order to handle time limitations, change the order of proposal, etc. It also handles the deletion of tags (some can only be downloaded once, others several times, with or without restrictions), any duplicates (either by deleting the duplicate, or by “adding” them, in the case of a commercial offer and if this option is envisaged). Based on a user profile, the interfacing device may also query remote servers itself, to offer each terminal tags that may be of interest (the profile being provided by the user and, if applicable, updated by the interfacing device based on an analysis of the prior requests received from the user).

According to a further feature, the interfacing terminal can provide a backup function of all or part of the data contained in a terminal, in encrypted form if applicable.

1. Secure interfacing device (20), suitable for storing at least one specific data sequence, referred to as a tag (30), and/or transferring the tag to at least one data storage and transmission terminal (1),
said tag including setting data (31) and informative data (32),
which comprises:
means (21) for obtaining at least one stream of multimedia data broadcast via one or a plurality of transmission media;
means for detecting and extracting at least one of said tags (30) and/or at least one item of information suitable for downloading at least one tag (30), in said data stream;
means (29) for managing and/or storing said tag(s);
means (27) for identifying and/or authenticating one of said terminals (1), using near field communication means (231);
means (23) for receiving a transmission request (2001) of at least one tag, sent by one of said terminals;
first means (24) for a radiofrequency transmission of said at least one tag to said terminal (1).

2. Interfacing device according to claim 1, wherein said obtaining means comprise means (210) for downloading said data stream, from at least one remote server (3).

3. Interfacing device according to claim 1, wherein said data stream is a broadcast signal.

4. Interfacing device according to claim 1, wherein said setting data (31) comprises time-stamp data (311), defining a validity start time and/or end time and/or a validity period, and in that said tag management and/or storage means (29) control the storage and/or transfer of said tags to at least one terminal on the basis of said time-stamp data (311).

5. Interfacing device according to claim 1, wherein said setting data (31) includes data (312) for characterizing said informative data,
and in that said tag management and/or storage means control the storage and/or transfer of said tags to at least one terminal based on a comparison between said characterization data and configuration information (2000) stored in said interfacing device and/or provided by one of said terminals.

6. Interfacing device according to claim 1, which comprises means (41) for managing the transfer of at least one tag to a terminal, comprising means for proposing the transfer of at least one tag (411), means for requesting the transfer of at least one tag (412) and means for transferring said tag (413).

7. Interfacing device according to claim 1, which comprises means for receiving a response to a tag (42), transmitted by one of said terminals, and means (43) for transmitting said response to a remote server (3).

8. Interfacing device according to claim 7, which comprises means (44) for certifying and/or authenticating said response, based on at least one certification and/or authentication data item transmitted by said transmission request.

9. Interfacing device according to claim 1, wherein said information for downloading said tag comprises at least one synchronization information item defining a validity start time and/or end time, a validity period and/or a synchronization data item with said tag to be downloaded,
and in that it comprises means (25) for controlling the download of said tag, based on said synchronization information.

10. Interfacing device according to claim 1, which comprises second means for radiofrequency transmission (26) with a telephone and/or Internet network (10) connection gateway (2).

11. Interfacing device according to claim 1, wherein said means (27) for identifying and authenticating a terminal, take account of identification and/or authentication information transmitted in said request sent by the terminal.

12. Interfacing device according to claim 1, which comprises setting (28), encoding and/or encryption (281) means based on setting, encoding and/or encryption data exchanged via said near field communication means.

13. Interfacing device according to claim 1, wherein said obtaining means comprise means for opening (211) and implementing a data transmission channel between a terminal and at least one remote server, via said connection gateway.

14. Interfacing device according to claim 13, wherein the means for opening (211) and implementing a data transmission channel comprise means (2110) for converting signals between said first radiofrequency transmission means and the second radiofrequency transmission means.

15. Interfacing device according to claim 1, wherein said first radiofrequency transmission means and/or said second radiofrequency transmission means belong to the group comprising communication means implementing a protocol such as ZigBee®, Bluetooth®, 6LoWPAN®, Ethernet® or Wifi.

16. Secure interfacing method, for storing at least one specific data sequence, referred to as a tag (30), and/or transferring the tag to at least one data storage and transmission terminal (1),
said tag comprising setting data (31) and informative data (32),
which comprises the following steps:
obtaining at least one stream of multimedia data broadcast via one or a plurality of transmission media;
detecting and extracting at least one of said tags and/or at least one item of information suitable for downloading at least one tag, in said data stream;
managing and/or storing said tag(s);
identifying and/or authenticating (27) one of said terminals (1), using near field communication means (231);
receiving (23) a transmission request (2001) of at least one tag, sent by one of said terminals;
radiofrequency transmission (24) of said at least one tag to said terminal (1).
